(19) United States
(12) Patent Application Publication
(10) Pub. No.: US 2016/0338389 A1
(43) Pub. Date: Nov. 24, 2016

(54) NUT-BASED BEVERAGE MADE WITH UNROASTED NUTS

(71) Applicant: WhiteWave Services, Inc., Denver, CO (US)

(72) Inventors: Mary B. Malone, Broomfield, CO (US); David Tiande Cai, Superior, CO (US)

(21) Appl. No.: 14/720,130

(22) Filed: May 22, 2015

(51) Int. Cl. A23L 1/36; A23L 2/38; B02C 23/18

(52) U.S. Cl. CPC A23L 1/366; A23L 2/38; B02C 23/18; A23V 2002/00

(57) ABSTRACT

According to some embodiments, a method for making a nut-based ingredient includes receiving or grinding a pre-cut material of unroasted nuts to a mean particle size between approximately 0.01 and 0.5 inches and further processing the pre-cut material to yield a mixture having a mean particle size less than approximately 0.003. Examples of steps for processing the pre-cut material include performing a grinding step using a grinding mill configured with a microcut head, performing homogenization (e.g., at 1500-3000 psi) and/or high pressure homogenization (e.g., at 7500-15,000 psi), and/or recirculating the mixture through a pump or mill. In certain embodiments, an example comprises grinding unroasted nuts without a pre-cutting step. The temperature of the nut-based ingredient does not exceed approximately 180 degrees Fahrenheit throughout processing from unroasted nuts to the nut-based ingredient.

### TECHNICAL FIELD

Particular embodiments relate generally to nut-based beverages, and more specifically to a nut-based beverage made with unroasted nuts.

### BACKGROUND

Consuming dairy milk provides a multitude of health benefits. Dairy milk may provide calcium, protein, and additional vitamins. However, some people do not consume dairy milk for various reasons, such as dairy allergies or lactose intolerance. Various plant-based products exist as alternatives to dairy milk, such as, for example, soy milk, almond milk, and coconut milk. Certain plant-based milks may provide nutrition, flavor, and appearance similar to dairy milk.

### SUMMARY OF EXAMPLE EMBODIMENTS

According to some embodiments, a method for making a nut-based ingredient includes manufacturing or receiving a pre-cut material of unroasted nuts having a mean particle size between approximately 0.01 and 0.5 inches. In some embodiments, manufacturing the pre-cut material comprises a grinding step in which a grinding mill configured with a coarse cutting head grinds unroasted nuts to yield the pre-cut material. The grinding step does not raise the temperature above approximately 180 degrees Fahrenheit. In some embodiments, receiving the pre-cut material comprises receiving a quantity of pre-cut material from a supplier, from a separate plant, or from a separate equipment line within the same plant that receives and processes the pre-cut material. In certain embodiments, the method comprises grinding unroasted nuts without a pre-cutting step. After manufacturing or receiving the pre-cut material or microcut material, the method further comprises processing the pre-cut or microcut material to yield a mixture having a mean particle size less than approximately 0.003 inches.

Examples of steps for processing the pre-cut material to reduce the mean particle size to less than approximately 0.003 inches include: performing a grinding step using a grinding mill configured with a microcut head, performing homogenization (e.g., at 1500-3000 psi) and/or high pressure homogenization (e.g., at 7500-15,000 psi), and/or recirculating the mixture through a pump (e.g., a shear pump) or mill. During the processing from unroasted nuts to the mixture having the mean particle size less than approximately 0.003 inches, the temperature should not exceed approximately 180 degrees Fahrenheit at least until a point in the process where the mixture is intentionally subjected to heat treatment, such as during pasteurization.

According to some embodiments, a method comprises adding unroasted nuts and water to a grinding mill configured with a microcut head and grinding the unroasted nuts and water to yield a slurry having a mean particle size less than approximately 0.003 inches. The ratio of unroasted nuts to water is at least 2:98 and up to approximately 45:55 by weight. The method further includes pumping the slurry through a heat exchanger for cooling, or pasteurization and subsequent cooling, to yield a nut-based ingredient.

According to some embodiments, a method for making a nut-based beverage includes receiving an ingredient comprising unroasted nuts that have been ground to a mean particle size less than approximately 0.003 inches and subsequently using the ingredient in the manufacture of nut milk. For example, the ingredient is sent to a batching system that adds water and other beverage ingredients to form a beverage mixture. The beverage mixture is processed (e.g., mixed, pasteurized, homogenized, and/or subjected to other suitable processing) to yield a finished nut-based beverage from unroasted nuts with particle size <0.003 inches.

Technical advantages of particular embodiments of the present disclosure include creating an unroasted nut ingredient for subsequent use in a nut-based beverage. The particles that make up the beverage may have a sufficiently small particle size to minimize the extent to which they impart grittiness to the beverage or settle to the bottom of the beverage over time. A technical advantage of certain embodiments allows for maintaining the temperature of the nut-based ingredient below approximately 180 degrees Fahrenheit throughout processing from unroasted nuts to the nut-based ingredient. Controlling the temperature may prevent the product from developing cooked flavors and may prevent lipid oxidation.

A technical advantage of certain embodiments includes maintaining the product at a consistency that can be efficiently and economically handled by manufacturing equipment throughout the manufacturing process. For example, the ground nut particles may have a powder consistency and/or a slurry made from the ground nuts with water may have a consistency that can be pumped by manufacturing equipment. Thus, it may be possible to process the unroasted nuts without the material taking on a doughy consistency that can be difficult for manufacturing equipment to handle and may also be difficult to keep at a sufficiently cool temperature (e.g., below 180 degrees Fahrenheit). Thus, certain embodiments may facilitate processing unroasted nuts to the nut-based ingredient in quantities acceptable for commercial purposes, such as at least 100 pounds of nut ingredient or 500 gallons of nut beverage.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example embodiment of a system for grinding unroasted nuts into pre-cut material and processing the pre-cut material into a nut-based ingredient of a suitable particle size for use in a nut based beverage;

FIG. 2 illustrates another example embodiment of a system for grinding unroasted nuts into pre-cut material and further processing the pre-cut material into a nut-based ingredient of a suitable particle size for use in a nut based beverage;

FIG. 3 illustrates another example embodiment of a system for grinding unroasted nuts into pre-cut material and further processing the pre-cut material into a nut-based ingredient of a suitable particle size for use in a nut based beverage; and

FIG. 4 illustrates an example embodiment of a system for manufacturing a nut/liquid slurry for use in a nut-based beverage, the slurry formed by grinding a mixture of unroasted nuts and water using a grinding head.

### DETAILED DESCRIPTION

Conventional nut-based beverages are made by mixing nut butter with other ingredients, such as water, flavors, vitamins, minerals, salts, sweeteners, stabilizers, emulsifiers, and/or other ingredients. The nut butters used in these conventional nut-based beverages are typically manufactured by grinding dry roasted or oil roasted nuts. The roasted nuts may impart cooked flavors to the nut-based beverage, which may not be preferred by some consumers. Additionally, roasted nuts may impart a darker color to the nut-based beverage than unroasted nuts, and consumers may prefer the nut-based beverage to have a lighter color. Thus, there is increasing consumer demand for beverages manufactured from unroasted nuts. However, a commercially viable manufacturing process for such beverages has not previously been identified.

In conventional nut butters, the nuts undergo a roasting process that reduces moisture content and releases oil which tends to make the nuts brittle and facilitates grinding the nuts to a nut butter of suitable particle size (max 500 μm, average 50 μm or less). Merely substituting unroasted nuts for roasted nuts in conventional manufacturing techniques has proven unsuccessful. For example, the resulting material forms a paste consistency similar to cookie dough or pie dough.

The unroasted almonds may be difficult for the grinding machinery to process such that applying a conventional grinding process to the unroasted almonds tends to generate heat that is difficult to dissipate because of the doughy texture. The friction created by the grinding equipment elevates the temperature of the paste to over approximately 160° F. At the elevated temperature, the paste undergoes browning reactions. The browning reactions create undesirable roasted flavor notes, similar to roasted nut butter. Without cooling, the elevated temperatures may cause chemical and/or microbiological reactions. Therefore, it is critical to cool the unroasted nut paste immediately after manufacture. Unfortunately, conventional nut processing systems fail to provide a viable commercial solution for cooling this type of material. For example, the paste consistency is difficult to break apart or pump, which makes heat transfer challenging and expensive. In addition, many challenges exist in handling the paste within a manufacturing facility, as the material is not conducive to pumping long distances.

Embodiments of the present disclosure provide methods for the commercial manufacture of nut-based ingredient made from unroasted nuts of a suitable particle size for use in a nut based beverage. The methods described below overcome issues presented in previous art and understood within the nut industry, while providing for a consumer preferred finished product. Particular embodiments provide an appropriate particle size reduction while limiting browning reactions and mitigating microbiological issues.

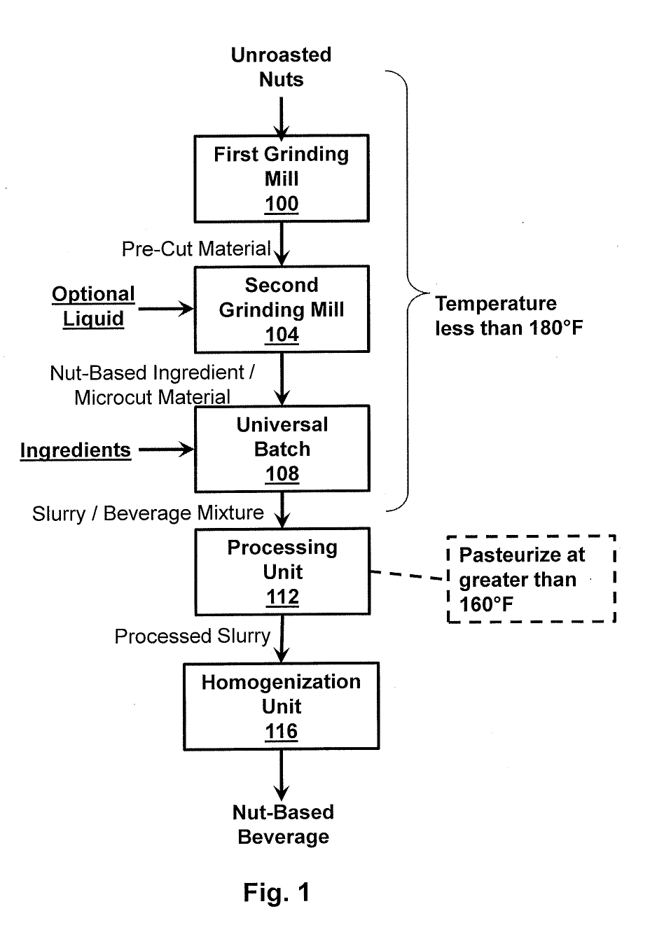

FIG. 1 illustrates an example embodiment of a system for processing, unroasted nuts into a nut-based ingredient of a suitable particle size for use in a nut based beverage. The final particle size may be selected to minimize the likelihood that the nut-based beverage has a gritty texture or that the particles settle to the bottom of the beverage over time. The system may allow for making the nut-based ingredient without raising the temperature above approximately 180 degrees Fahrenheit until final processing (e.g., HTST and/or UHT pasteurization). In particular embodiments, the system includes a first grinding mill 100, a second grinding mill 104, a universal batch unit 108, a processing unit 112, and a homogenization unit 116.

First grinding mill 100 receives unroasted nuts. As used herein, nuts may refer to nuts and/or nut fragments having a particle size of at least 0.5 inches. Unroasted nuts may refer to nuts that have not been subjected to dry roasting or oil roasting. Any suitable type of nut or combination of types of nuts may be used. Examples of types of nuts include almonds, pistachios, hazelnuts, pine nuts, cashews, walnuts, pecans, peanuts, Brazil nuts, Macadamia nuts, breadnuts, chestnuts, coconuts, and/or other edible nuts. The one or more types of nuts may be selected to produce a desirable balance of fat content, taste, consistency, and nutrients provided. In particular embodiments, nuts may optionally be blanched to facilitate removing the natural skin (if any) and/or to protect integrity (e.g., by inactivation of undesirable enzymes). In some embodiments, nuts with skin may be used to directly make the nut ingredient, slurry, and beverage.

First grinding mill 100 grinds the unroasted nuts to form a pre-cut material, such as a powder. The pre-cut material has a mean particle size between approximately 0.01 and 0.5 inches, such as between 0.01 and 0.1 inches, for example, between 0.04 and 0.06 inches. Any suitable technique for generating the pre-cut material may be used. For example, a Comitrol® 1700 grinding mill or other grinding mill capable of generating the pre-cut material may be used. In some cases, the step of generating the pre-cut material may be performed by a supplier, and the supplier may ship the pre-cut material to a beverage manufacturer for processing into a nut-based ingredient that can be used in a nut-based beverage.

First grinding mill 100 may be configured with a coarse cutting head. In some embodiments, the coarse cutting head may be comprised of uniformly spaced, knife columns arranged in a circular fashion and held in place by thin separators. The leading edge of each knife is a sharp knife edge. When the nuts are revolved inside this ring of blades at a very high speed, centrifugal force pushes the nuts against the blades at a pressure that causes the blades to grind the nuts into the pre-cut material. The coarse cutting head may be made of a wear and abrasion resistant alloy.

The distance between the separators and the knife columns defines the opening through which the nut particles must pass and helps determine the final particle size and shape. In general, a coarse cutting head may refer to a cutting head for which the size of the opening through which the nut particles must pass is larger than the size of the opening through which the nut particles must pass in a microcut head (further described below). As an example, in a coarse cutting head, the blades may be uniformly spaced with a space between blades having a value between approximately 0.01 and 0.5 inches, such as between 0.01 and 0.1 inches, for example, between 0.04 inches to 0.06 inches between blades.

The grinding step performed by first grinding mill 100 does not raise the temperature above approximately 180 degrees Fahrenheit. In some embodiments, the temperature is kept sufficiently low due to the selection of the coarse cutting head, which does not generate undo heat due to friction. Thus, the temperature may be kept sufficiently cool without requiring a cooling step or specialized cooling equipment.

Second grinding mill 104 receives pre-cut material (e.g., the pre-cut material created by first grinding mill 100). In some embodiments, the pre-cut material may be dispensed directly from first grinding mill 100 into second grinding mill 104 via any suitable interconnecting components. In other embodiments, the pre-cut material may be packed in drums or boxes and stored for later use at the same plant or transported to another plant for processing at a later time.

Second grinding mill 104 grinds the pre-cut material with a liquid, such as water, to yield a microcut material mixture (e.g., the nut-based ingredient) having a mean particle size less than approximately 0.003 inches. Any suitable grinding mill capable of generating the microcut material may be used. As an example, in some embodiments a Comitrol® 1500 may be used.

The second grinding mill 104 may be configured with a microcut head. The microcut head may be similar to a coarse cut head with blades spaced more closely together. The blades may be uniformly spaced and carefully positioned so that friction, which produces heat, is minimized. In some embodiments, the microcut head may be configured with an opening between blades having a value between approximately 0.001 inches to 0.003 inches. The percentage of open area in the microcut head may have a value between approximately 1% and 10%. The microcut head may be configured to provide a depth of cut having a value between approximately 0.001 inches and 0.005 inches in some embodiments. The microcut head may be configured to rotate at any suitable rpm, such as a value between 1000 and 10,000 rpm (e.g, 1500 rpm, 1700 rpm, 9300 rpm, or other suitable value).

The grinding step performed by second grinding mill 104 does not raise the temperature above approximately 180 degrees Fahrenheit. In some embodiments, the temperature is kept sufficiently low due to the use of pre-cut nuts (e.g., rather than whole nuts), and/or the addition of liquid (e.g., water) so that the microcut grinding step does not generate undo heat due to friction. The nuts and liquid can be metered in any appropriate ratio. In certain embodiments, the nut to liquid ratio is in the range between 1:2 to 1:20. In general, increasing the amount of liquid tends to lower the temperature. The temperature can also be lowered by using a liquid that is cold. In certain embodiments, second grinding mill 104 may be a roller mill and the cooling can be achieved by circulating cold water, glycol, or other coolant into the inside of the rollers. Thus, the temperature may be kept sufficiently cool without requiring a cooling step or specialized cooling equipment.

The microcut material may be dispensed into universal batch unit 108. In some embodiments, universal batch unit 108 may mix the microcut material with one or more other ingredients of the nut-based beverage to form a slurry. Examples of other ingredients may include one or more of liquid (e.g., water), salts, sweeteners, stabilizers, emulsifiers, nutritional supplements (e.g., vitamins and/or minerals), flavorings (e.g., vanilla, chocolate, almond, hazelnut, fruit flavorings, etc.), colorants, antioxidants, bulking agents, or any other suitable ingredients. The nut-based beverage may include none, some, or all of the preceding ingredients, and other ingredients could be used.

The slurry/mixture of ingredients may be dispensed from universal batch unit 108 to processing unit 112. Processing unit 112 may refer to any suitable component or combination of components that facilitate processing the slurry into a finished nut-based beverage. As an example, processing unit 112 may comprise a pasteurization unit. In some embodiments, the pasteurization unit heats the slurry to kill spoilage microorganisms and extend the product shelf life. Pasteurization unit may perform any suitable type of pasteurization such as UHT pasteurization (e.g., subjecting the slurry to a temperature between approximately 275° F. and 305° F. for 1-15 seconds) or HTST pasteurization (e.g., subjecting the slurry to a temperature between approximately 160° F. and 165° F., for about 15 to 30 seconds).

The processed slurry may be dispensed from processing unit 112 to homogenization unit 116. Homogenization unit 116 may perform single-stage or multi-stage homogenization. In multi-stage homogenization, homogenization unit 116 may perform a first homogenization stage at one pressure and a second homogenization stage at a different pressure. In some embodiments, homogenization unit 116 homogenizes the slurry at a pressure in the range of approximately 1500 to 3000 pounds per square inch (psi) to further reduce the mean particle size to a value below approximately 0.002 inches and to make a more stable emulsion product or suspension. In certain embodiments, homogenization may be performed at a pressure higher than 3000 psi (in addition to or in the alternative to homogenizing the slurry at 1500-3000 psi). For example, high pressure homogenization could be performed using a pressure in the range of approximately 7500-15000 psi.

Homogenization unit 116 may optionally dispense the homogenized slurry to any suitable downstream equipment (e.g., if further processing is needed to make a finished nut-based beverage). The finished nut-based beverage may be dispensed into any suitable outlet, such as a refrigerated storage system or a packaging system that fills bottles or cartons for distribution to consumers.

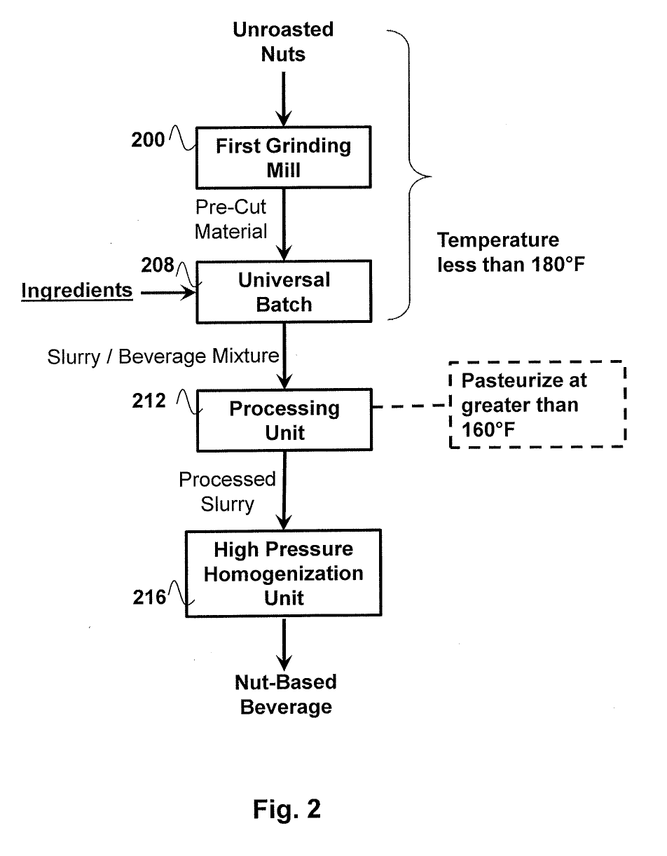

FIG. 2 illustrates another example embodiment of a system for processing unroasted nuts into a nut-based ingredient of a suitable particle size for use in a nut based beverage. The final particle size may be selected to minimize the likelihood that the nut-based beverage has a gritty texture or that the particles settle to the bottom of the beverage over time. The system may allow for making the nut-based ingredient without raising the temperature above approximately 180 degrees Fahrenheit until final processing (e.g., HTST and/or UHT pasteurization). In particular embodiments, the system includes a first grinding mill 200, a universal batch unit 208, a processing unit 212, and a high pressure homogenization unit 216.

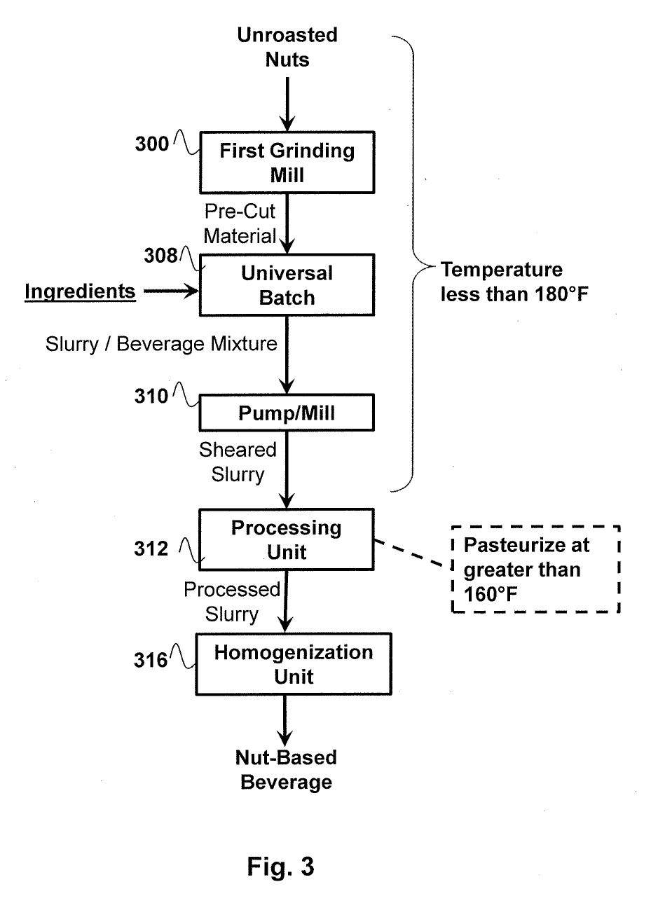

First grinding mill 200, universal batch unit 208, and processing unit 212 may be analogous to and may provide functionality similar to first grinding mill 100, universal batch 108, and processing unit 112 of FIG. 1, respectively. In general, the high pressure homogenization unit 216 may be similar to homogenization unit 116. High pressure homogenization unit 216 may be configured to operate at higher pressures in order to facilitate substantial particle reduction at the homogenization stage. Thus, in the system of FIG. 2, a second grinding mill (such as grinding mill 104) is optional and can be omitted. In some embodiments, high pressure homogenization unit 216 homogenizes the slurry at a pressure in the range of approximately 7500 to 15,000 pounds per square inch (psi) to yield the mean particle size less than approximately 0.003 inches. High pressure homogenization may be performed in one stage or multiple stages (e.g., two stage homogenization, where a different psi could be used during each stage). Water can be added and mixed to hydrate the pre-cut nuts to facilitate the particle reduction and stability during homogenization. FIG. 3 illustrates yet another example embodiment of a system for processing unroasted nuts into a nut-based ingredient of a suitable particle size for use in a nut based beverage. The final particle size may be selected to minimize the likelihood that the nut-based beverage has a gritty texture or that the particles settle to the bottom of the beverage over time. The system may allow for making the nut-based ingredient without raising the temperature above approximately 180 degrees Fahrenheit until final processing (e.g., HTST and/or UHT pasteurization). In particular embodiments, the system includes a first grinding mill 300, a universal batch unit 308, a shear pump 310, a processing unit 312, and a homogenization unit 316.

First grinding mill 300, universal batch unit 308, processing unit 312, and homogenization unit 316 may be analogous to and may provide functionality similar to first grinding mill 100, universal batch 108, processing unit 116, and homogenization unit 116 of FIG. 1, respectively. After exiting universal batch 308, the slurry may be recirculated through shear pump 310 until the slurry has a mean particle size less than approximately 0.003 inches. In certain embodiments, the weight ratio of nuts to liquid during this stage is in the range of 1:2 (e.g., for a beverage concentrate) to 1:49 (e.g., for a beverage). Thus, in the system of FIG. 3, a second grinding mill (such as grinding mill 104) is optional and can be omitted.

Any suitable shear pump 310 (which may be interchangeably referred to as a shear mill) may be used. As an example, a DynaShear® may be used. The DynaShear may provide a primary axial stage and a secondary radial stage. The axial stage consists of a high flow rotor feeding into a stator with multiple small ports, forcing material between their faces and out through the ports. This mechanical and hydraulic action causes a shearing action and pre-mixes the material prior to the secondary stage. The radial stage consists of a radial, high flow rotor discharging through a slotted stator providing additional mechanical and hydraulic shear. The centrifugal force at this stage allows for the mixture to be pushed away from the shaft and along the radius of the stator, with high speed expulsion occurring at the edge of the slots. This stage provides a momentum change in the flow, allowing time for further refining to be done on the mixture. In certain embodiments, the product discharge pressure should be at least 15 pound per square inch over the barrier fluid pressure to prevent the barrier fluid leaking into the product, and the barrier fluid must be at least 30 pounds per square inch to proper lubricate outboard seal.

As another example, a Boston Shearmill™ may be used as shear pump mill 310. The Boston Shearmill may be configured with one or more shear heads, each having a multi-slot rotor turning at high speeds in close proximity to a multi-port stator. Each shear head may have a double ring design providing two stages of mixing at both the rotor and stator. Shearing may occur as the mixture passes through the rotor slots, the first ring of stator slots, and/or the second ring of slots in the rotor and stator.

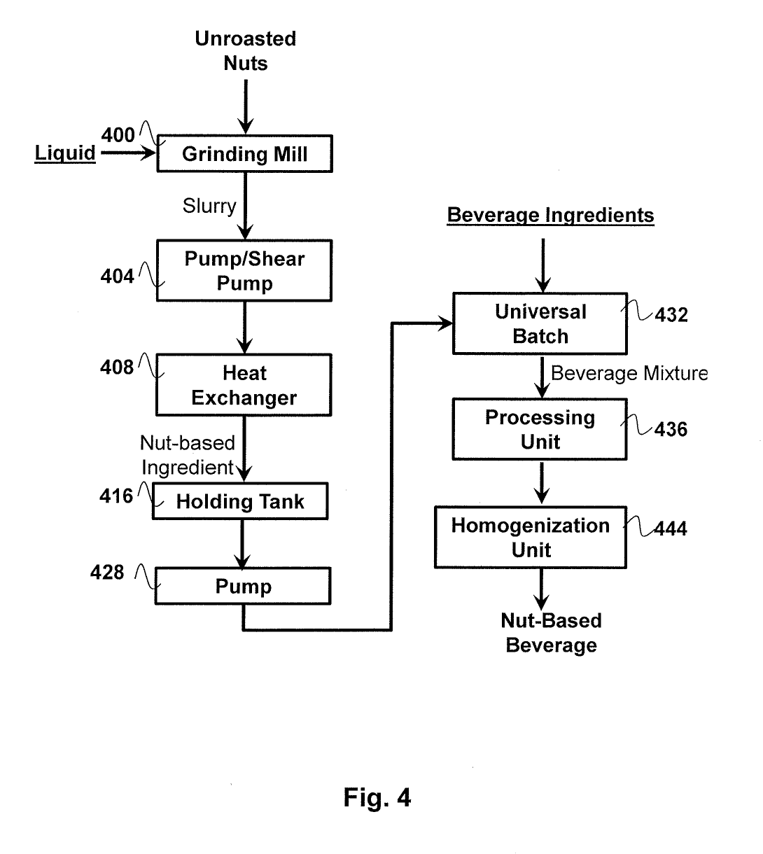

FIG. 4 illustrates another example embodiment of a system for processing unroasted nuts into a nut-based beverage of a suitable particle size. The final particle size may be selected to minimize the likelihood that the nut-based beverage has a gritty texture or that the particles settle to the bottom of the beverage over time. The system may allow for making the nut-based beverage without raising the temperature above approximately 180 degrees Fahrenheit except for during preliminary and final processing (e.g., HTST and/or UHT pasteurization). As further discussed below, the method involves adding liquid when grinding the unroasted nuts. Adding the liquid may make it easier for the grinding mill to process the unroasted nuts. Thus, in some embodiments, a microcut head may be used at the outset such that the step of grinding the unroasted nuts into a pre-cut material using a coarse cutting head may be omitted.

The method begins by adding unroasted nuts and water to a grinding mill 400. The ratio of unroasted nuts to water should allow the resulting slurry to be flowable/pumpable. For example, the ratio of nuts to liquid (e.g., water) should not exceed approximately 45:55. In certain embodiments, a suitable ratio of nuts to liquid may be in the range of approximately 2:98 (which in certain embodiments may be used to make a beverage directly) to 35:65 (which in certain embodiments may be used to make a nut base or concentrate). Grinding mill 400 is configured with a microcut head, such as the microcut head described above with respect to FIG. 1. The unroasted nuts and water are ground to yield a slurry having a mean particle size less than approximately 0.003 inches. By grinding the unroasted nuts with sufficient water, the slurry can be kept from forming a doughy consistency and may be maintained below 180 degrees Fahrenheit, for example, the temperature may be maintained below 150 degrees Fahrenheit. However, adding the water to the nuts may start microbial activity. To reduce the microbial activity, cooling alone or pasteurization and subsequent cooling may be performed prior to sending the slurry to downstream equipment, such as a holding tank 416 for later use or to the universal batch 432.

Next, one or more pumps 404 pump the slurry from grinding mill 400 to downstream equipment. In some embodiments, at least one pump 404 is a shear pump. The slurry may be recirculated through the shear pump to further reduce the mean particle size and to create a homogenous slurry mixture prior to storage holding tank 416. For example, the slurry may be recirculated through the shear pump until the mean particle size is approximately 0.003 inches or less.

Pump(s) 404 may pump the slurry through a heat exchanger 408. Heat exchanger 408 may control the temperature of the slurry. For example, heat exchanger 408 may comprise multiple sections. Each section of heat exchanger 408 may control the temperature of the slurry at different points in the treatment process. For example, the slurry received from pump 404 may be received at a heating section of heat exchanger 408 and may exit at a cooling section of heat exchanger 408. The heating section may heat the incoming slurry to HTST or UHT pasteurization temperatures. The cooling section may cool the outgoing slurry from HTST or UHT pasteurization temperatures to a refrigeration temperature, such as temperature greater than 32 degrees Fahrenheit and less than 50 degrees Fahrenheit. Although the previous example describes using heat exchanger 408 for pasteurization followed by cooling, in other embodiments it could be used for cooling alone without pasteurization.

The nut-based ingredient may be moved from heat exchanger 408 to holding tank 416 for any suitable amount of time. Holding tank 416 holds the nut-based ingredient until the ingredient is ready for further processing by downstream equipment. Holding tank 416 may provide agitation and jacket cooling to keep the nut-based ingredient sufficiently mixed and cool. One or more pumps 428 (such as regular pumps or shear pumps) may pump the pasteurized or cooled nut-based ingredient to universal batch 432.

Universal batch 432 mixes the nut-based ingredient with one or more beverage ingredients to yield a beverage mixture. Examples of other ingredients may include one or more of liquid (e.g., water), salts, sweeteners, stabilizers, emulsifiers, nutritional supplements (e.g., vitamins and/or minerals), flavorings (e.g., vanilla, chocolate, almond, hazelnut, fruit flavorings, etc.), colorants, antioxidants, bulking agents, or any other suitable ingredients. The nut-based beverage may include none, some, or all of the preceding ingredients, and other ingredients could be used.

Processing unit 436 may be analogous to and may perform functions similar to those of processing unit 116 of FIG. 1. In some embodiments, processing unit 436 includes a pasteurization unit for pasteurizing the beverage mixture. Homogenization unit 444 homogenizes the beverage mixture at any suitable pressure, such as pressure in the range of approximately 1500 to 3000 pounds per square inch (psi) or higher, to further reduce the mean particle size. In some embodiments, the final mean particle size may have a value below approximately 0.002 inches, such as a value of 0.001 inches or less. Homogenization unit 444 outputs a nut-based beverage, such as an almond milk made from unroasted almonds in some embodiments.

Modifications, additions, or omissions may be made to the systems and apparatuses disclosed herein without departing from the scope of the disclosure. The components of the systems and apparatuses may be integrated or separated. Moreover, the operations of the systems and apparatuses may be performed by more, fewer, or other components. Modifications, additions, or omissions also may be made to the methods disclosed herein without departing from the scope of the disclosure. As an example, pasteurization may be optional in each of the methods described herein (e.g., certain embodiments include pasteurization, whereas other embodiments do not include pasteurization). The methods may include more, fewer, or other steps. Additionally, steps may be performed in any suitable order. As one example, although FIGS. 1-4 illustrate the homogenization unit after the processing unit, in alternative embodiments the homogenization unit can be placed before the processing unit.

The above description of the embodiments does not constrain this disclosure. Other changes, substitutions, and alterations are possible without departing from the scope of this disclosure, as defined by the following claims.

What is claimed is:

1. A method, comprising:
manufacturing or receiving pre-cut material made by grinding unroasted nuts, the pre-cut material having a mean particle size between approximately 0.01 and 0.5 inches; and
processing the pre-cut material to yield a nut-based ingredient having a mean particle size less than approximately 0.003 inches;
wherein processing the pre-cut material does not raise the temperature above approximately 180 degrees Fahrenheit.

2. The method of claim 1, wherein the pre-cut material is manufactured according to a first grinding step in which a first grinding mill configured with a coarse cutting head grinds the unroasted nuts to yield the pre-cut material, wherein the first grinding step does not raise the temperature above approximately 180 degrees Fahrenheit.

3. The method of claim 1, wherein processing the pre-cut material comprises:
adding liquid to the pre-cut material to yield a slurry;
recirculating the slurry through a pump or mill until the slurry has a mean particle size less than approximately 0.003 inches.

4. The method of claim 1, wherein processing the pre-cut material comprises:
adding liquid in connection with grinding the pre-cut material, the grinding performed using a grinding mill configured with a microcut head to yield a microcut material, the microcut material having a mean particle size less than approximately 0.003 inches.

5. The method of claim 1, further comprising:
mixing the nut-based ingredient with one or more other ingredients to yield a beverage mixture; and
pasteurizing and then homogenizing the beverage mixture, the homogenizing performed at a pressure in the range of approximately 1500 to 3000 pounds per square inch (psi).

6. The method of claim 1, further comprising:
mixing the nut-based ingredient with one or more other ingredients to yield a beverage mixture; and
pasteurizing and homogenizing the beverage mixture, the homogenizing performed at a pressure in the range of approximately 7500 to 15,000 pounds per square inch (psi) until the mean particle size is reduced to a value below approximately 0.002 inches.

7. A product made according to a process that comprises:
manufacturing or receiving pre-cut material made by grinding unroasted nuts, the pre-cut material having a mean particle size between approximately 0.01 and 0.5 inches; and
processing the pre-cut material to yield a nut-based ingredient having a mean particle size less than approximately 0.003 inches;
wherein processing the pre-cut material does not raise the temperature above approximately 180 degrees Fahrenheit.

8. The product of claim 7, wherein the pre-cut material is manufactured according to a first grinding step in which a first grinding mill configured with a coarse cutting head grinds the unroasted nuts to yield the pre-cut material, wherein the first grinding step does not raise the temperature above approximately 180 degrees Fahrenheit.

9. The product of claim 7, wherein processing the pre-cut material comprises:
adding liquid to the pre-cut material to yield a slurry;
recirculating the slurry through a pump or mill until the slurry has a mean particle size less than approximately 0.003 inches.

10. The product of claim 7, wherein processing the pre-cut material comprises:
adding liquid in connection with grinding the pre-cut material, the grinding performed using a grinding mill configured with a microcut head to yield a microcut material, the microcut material having a mean particle size less than approximately 0.003 inches.

11. The product of claim 7, the process further comprising:
mixing the nut-based ingredient with one or more other ingredients to yield a beverage mixture; and
pasteurizing and then homogenizing the beverage mixture, the homogenizing performed at a pressure in the range of approximately 1500 to 3000 pounds per square inch (psi).

12. The product of claim 7, the process further comprising:
mixing the nut-based ingredient with one or more other ingredients to yield a beverage mixture; and
pasteurizing and homogenizing the beverage mixture, the homogenizing performed at a pressure in the range of approximately 7500 to 15,000 pounds per square inch (psi) until the mean particle size is reduced to a value below approximately 0.002 inches.

13. A method, comprising:
adding unroasted nuts and water to a grinding mill, wherein the ratio of unroasted nuts to water is at least 2:98, the grinding mill configured with a microcut head;
grinding the unroasted nuts and water to yield a slurry having a mean particle size less than approximately 0.003 inches.

14. The method of claim 13, further comprising pumping the slurry through a heat exchanger that cools or pasteurizes and then cools the slurry to yield a nut-based ingredient.

15. The method of claim 14, further comprising:
mixing the nut-based ingredient with one or more beverage ingredients to yield a beverage mixture;
pasteurizing and then homogenizing the beverage mixture, the homogenizing performed at a pressure in the range of approximately 1500 to 3000 pounds per square inch (psi).

16. The method of claim 13, further comprising:
pumping the slurry through a pump that further reduces the mean particle size below 0.002 inches and/or makes the slurry homogenous; and
after pumping the slurry through the pump, pumping the slurry through a heat exchanger that cools or pasteurizes and then cools the slurry.

17. A product made according to a process that comprises:
adding unroasted nuts and water to a grinding mill, wherein the ratio of unroasted nuts to water is at least 2:98, the grinding mill configured with a microcut head;
grinding the unroasted nuts and water to yield a slurry having a mean particle size less than approximately 0.003 inches.

18. The product of claim 17, wherein the process further comprises pumping the slurry through a heat exchanger that cools or pasteurizes and then cools the slurry to yield a nut-based ingredient.

19. The product of claim 18, wherein the process further comprises:
mixing the nut-based ingredient with one or more beverage ingredients to yield a beverage mixture;
pasteurizing and then homogenizing the beverage mixture, the homogenizing performed at a pressure in the range of approximately 1500 to 3000 pounds per square inch (psi).

20. The product of claim 17, wherein the process further comprises:
pumping the slurry through a pump that further reduces the mean particle size below 0.003 inches and/or makes the slurry homogenous; and
after pumping the slurry through the pump, pumping the slurry through a heat exchanger that cools or pasteurizes and then cools the slurry.
